(19) United States
(12) Patent Application Publication
(10) Pub. No.: US 2005/0034949 A1
(43) Pub. Date: Feb. 17, 2005

(54) Foldable bag and method

(75) Inventor: Evan John Emlyn Davies, Gibsonia, PA (US)

Correspondence Address: Ansel M. Schwartz;Suite 304, 201 N. Craig Street, Pittsburgh, PA, 15213, US

(73) Assignee: Airway Industries, Inc.

(21) Appl. No.: 10/913,856

(22) Filed: Aug. 6, 2004

Related U.S. Application Data
(60) Provisional application No. 60/495,217, filed on Aug. 13, 2003.

(51) Int. Cl. B67D 5/378; B67D 5/33; B67D 5/32; B67B 5/00; A45C 13/30

(52) U.S. Cl. 190/107; 190/111; 190/18 A; 190/115

(57) ABSTRACT

A foldable bag including a first rigid container having a storage space. The bag includes a second rigid container having a storage space which is rotatably connected to the first rigid container so the second container can go from a first position in series with the first portion container to a second position in parallel with the first container, and any angular relationship therebetween. A method for using a bag including the steps of folding a first rigid container having a storage space connecting with a second rigid container having a storage space onto the second rigid container to place the first container and the second container in parallel. There is the step of placing the first container and second container into a location that conforms with the first container and the second container in a folded state.

### FIELD OF THE INVENTION

The present invention pertains to a foldable bag. More specifically, the present invention pertains to a foldable bag having at least a first container and a second container that can move relative to each other so they can be placed into a state where they conform with the location where they will be stored.

### BACKGROUND OF THE INVENTION

Storage of bags, such as suitcases or luggage, is always made more difficult because the space available for the storage of the bag does not conform with the shape of the bag. This results in many cases of either not being able to use a desired bag, or space being wasted because the different objects that are being stored do not conform with the available space. The present invention provides for the ability of the bag, which has at least two distinct rigid containers, to change shape to conform to the space that is available for storage.

### SUMMARY OF THE INVENTION

The present invention pertains to a foldable bag. The bag comprises a first rigid container having a storage space. The bag comprises a second rigid container having a storage space which is rotatably connected to the first rigid container so the second container can go from a first position in series with the first portion container to a second position in parallel with the first container, and any angular relationship therebetween.

The present invention pertains to a method for using a bag. The method comprises the steps of folding a first rigid container having a storage space connecting with a second rigid container having a storage space onto the second rigid container to place the first container and the second container in parallel. There is the step of placing the first container and second container into a location that conforms with the first container and the second container in a folded state.

### BRIEF DESCRIPTION OF THE DRAWINGS

In the accompanying drawings, the preferred embodiment of the invention and preferred methods of practicing the invention are illustrated in which:

FIG. 1 is a rear perspective view of the bag of the present invention.

FIG. 2 is a front perspective view of the second container of the bag of the present invention.

FIG. 3 is a front perspective view of the bag of the present invention.

FIG. 4 is a front view of the bag of the present invention.

FIG. 5 is a front perspective view of the bag of the present invention.

FIG. 6 is a perspective view of bags of the present invention in a vehicle.

### DETAILED DESCRIPTION

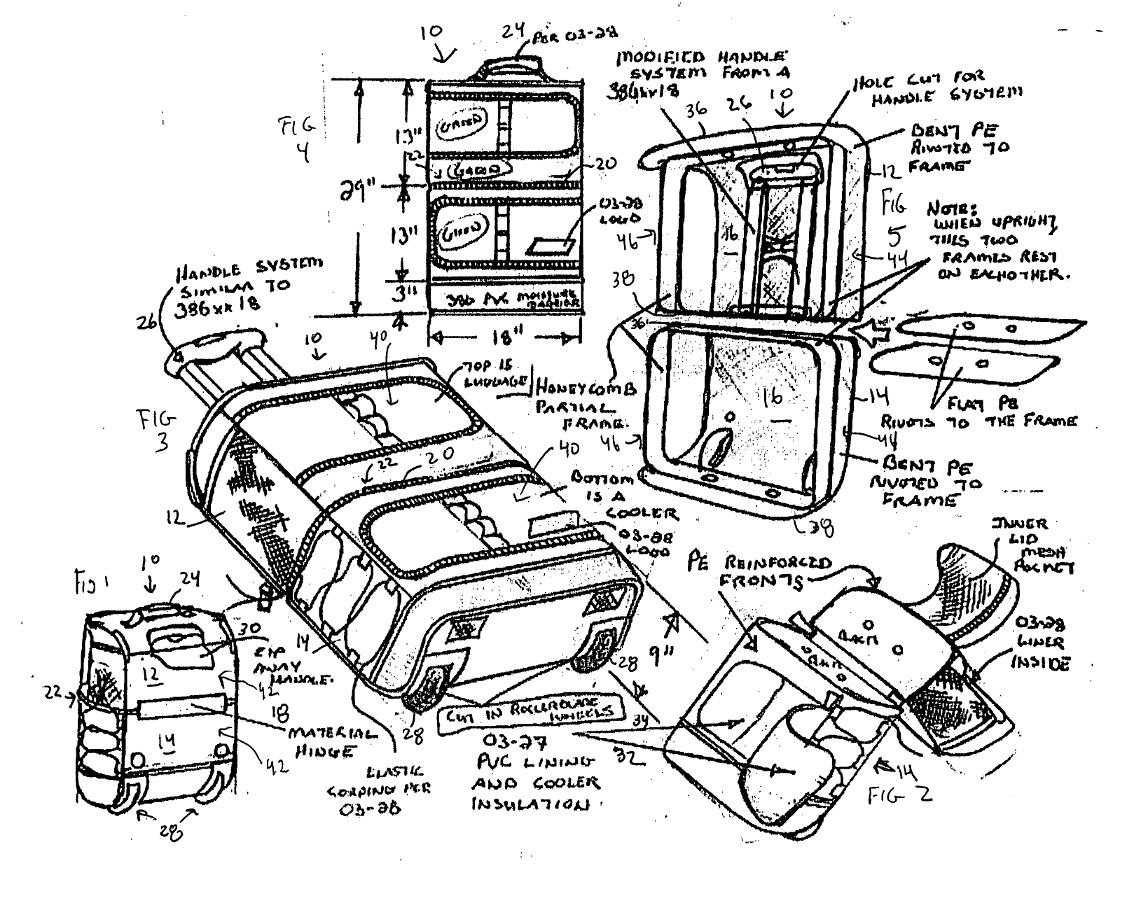

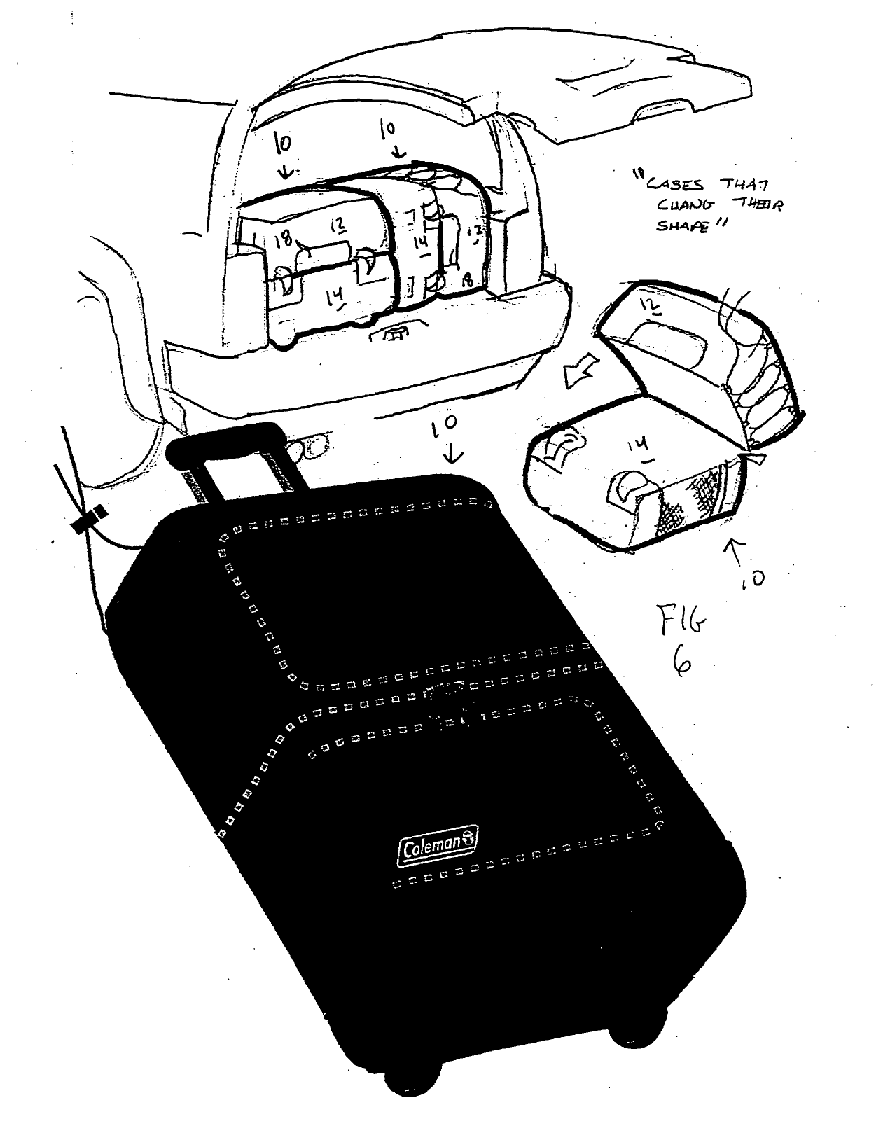

Referring now to the drawings wherein like reference numerals refer to similar or identical parts throughout the several views, and more specifically to FIGS. 1-6 thereof, there is shown a foldable bag 10. The bag 10 comprises a first rigid container having a storage space 16. The bag 10 comprises a second rigid container having a storage space 16 which is rotatably connected to the first rigid container so the second container 14 can go from a first position in series with the first portion container to a second position in parallel with the first container 12, and any angular relationship therebetween.

The bag 10 preferably includes a hinge 18 connected to the first container 12 and the second container 14. Preferably, the bag 10 includes a zipper 20 disposed along the edge 22 of the first container 12 and the second container 14 that is zipped to fix the first container 12 and the second content together when they are in series.

Preferably, the first container 12 has a fixed handle 24. The first container 12 preferably has an extendable handle 26. Preferably, the second container 14 has a set of wheels 28. The first container 12 preferably has a flap 30 that covers the extendable handle 26 when the extendable handle 26 is in a retracted state in the first container 12. Preferably, the second container 14 is a cooler having PVC lining 32 and cool insulation 34 about the storage space 16 of the second container 14. The first and second containers 12, 14 each have a top side 36, bottom side 38, front side 40, back side 42, right side 44 and a left side 46, together defining a rectangular shape.

The present invention pertains to a method for using a bag 10. The method comprises the steps of folding a first rigid container having a storage space 16 connecting with a second rigid container having a storage space 16 onto the second rigid container to place the first container 12 and the second container 14 in parallel. There is the step of placing the first container 12 and second container 14 into a location that conforms with the first container 12 and the second container 14 in a folded state. The location can be in a vehicle, closest, chest, under a bed, on a shelf, or across a bench, for instance.

Preferably, there is the step of rotating the first container 12 relative to the second container 14 about a hinge 18 connected to the first container 12 and the second container 14 until the first container 12 and the second container 14 are in parallel. There is preferably the step of fixing the first container 12 and second contended together. Preferably, there is the step of extending a handle from the first container 12 for pulling the first container 12 and the second container 14. The pulling step preferably includes the step of pulling the first container 12 and the second container 14 on wheels 28 connected to the second container 14.

In the operation of the invention, the foldable, otherwise called the Shape Shifter was designed to specifically address two markets: 1) The market for luggage outside of Air Travel. 2) The market for a bag that will change shapes and positions to accommodate the space provided for it. With these two premises in mind, the Shape Shifter was developed. One should note that even though this item was designed to work outside of Air Travel, the dimensions are such that they would meet the standard airline linear measurement requirements. The Shape shifter could be used for air travel, the design would simply have to manifest itself to that market.

Essentially, the shape shifter is two (cubically shaped) (although could be three or four) packing cavities connected by a material and, or rigid hinge 18 mechanism. The two packing cavities may be the same in size or uneven depending on the design and application. The overall shape and is also subject to change based on the design and application. The overall design may be used with wheels 28 and a telescoping trolley handle or it may be used without. The shape shifter is designed to hold secure in an upright or horizontally extended position by way of zipper 20, clips or any other securing method that would keep the shape shifter from folding. When the securing method is disengaged, the Shape Shifter will fold to form a cube or any angular shape in between so that it may fit into a multiple array of packing spaces.

When in a non-upright position, the shape shifter was designed to bend around the seats of cars (or any other transportation vehicle with seats) where one portion of the shape shifter resides in the foot well and the other portion resides on the posterior section of the seat. In this position, the exposed inner half of the shape shifter (the two inner ends on either side of the hinge 18) may be used for accessory storage where such conveniences as cup holders may be employed. This particular rendition of the shape shifter contains an insulated cooler in the lower half and a lined packing cavity in the upper half. Depending on the application or market, the shape shifter can lend itself to a number of specialized faculties such as: a wet/dry compartments for beach or aquatic activities, storage for picnicking, tool storage or tackle boxes for sporting and fishing.

Materials for the Foldable Bag 10

600 Denier Polyester Fabric with water resistant coating
75 Denier polyester liner material
Diamond texture roller formed PVC (used as a moisture barrier, anti slip and abrasion protection).
1½ inch nylon webbing
1 inch nylon webbing
Memory Frame
PE board
ABS wheel housings
Molded carry handles
Telescoping trolley handle system
PVC textured piping
½ inch binding tape
PVC three color molded logo
#8 delrin zipper tapes
PVC lining with insulation material
Molded ABS wheels

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A foldable bag comprising:
a first rigid container having a storage space; and
a second rigid container having a storage space which is rotatably connected to the first rigid container so the second container can go from a first position in series with the first portion container to a second position in parallel with the first container, and any angular relationship there between.

2. A bag as described in claim 1 including a hinge connected to the first container and the second container.

3. A bag as described in claim 2 including a zipper disposed along an edge of the first container and the second container that is zipped to fix the first container and the second content together when they are in series.

4. A bag as described in claim 3 wherein the first container has a fixed handle.

5. A bag as described in claim 4 wherein the first container has an extendable handle.

6. A bag as described in claim 5 wherein the second container has a set of wheels.

7. A bag as described in claim 6 wherein the first container has a flap that covers the extendable handle when the extendable handle is in a retracted state in the first container.

8. A bag as described in claim 7 wherein the second container is a cooler having PVC lining and cool insulation about the storage space of the second container.

9. A bag as described in claim 8 wherein the first and second containers each have a top side, bottom side, front side, back side, right side and a left side, together defining a rectangular shape.

10. A method for using a bag comprising the steps of:
folding a first rigid container having a storage space connecting with a second rigid container having a storage space onto the second rigid container to place the first container and the second container in parallel; and
placing the first container and second container into a location that conforms with the first container and the second container in a folded state.

11. A method as described in claim 10 including the step of rotating the first container relative to the second container about a hinge connected to the first container and the second container until the first container and the second container are in parallel.

12. A method as described in claim 11 including the step of fixing the first container and second contended together.

13. A method as described in claim 12 including the step of extending a handle from the first container for pulling the first container and the second container.

14. A method as described in claim 13 wherein the pulling step includes the step of pulling the first container and the second container on wheels connected to the second container.
